(19) United States
(12) Patent Application Publication
(10) Pub. No.: US 2009/0317781 A1
(43) Pub. Date: Dec. 24, 2009

(54) MEDICAL INSTRUCTION SYSTEM

(75) Inventor: George Valentine Eastland Oosthuizen, Auckland (NZ)

Correspondence Address: NIXON & VANDERHYE, PC, 901 NORTH GLEBE ROAD, 11TH FLOOR, ARLINGTON, VA, 22203, US

(73) Assignee: GO VIRTUAL MEDICAL LIMITED, Auckland (NZ)

(21) Appl. No.: 12/226,865

(22) PCT Filed: Aug. 28, 2006
(86) PCT No.: PCT/NZ2006/000215

§ 371 Date: Apr. 8, 2009

(30) Foreign Application Priority Data
Aug. 29, 2005 (NZ) 542066
Jun. 30, 2006 (NZ) 548262

(51) Int. Cl. G09B 23/28

(52) U.S. Cl. 434/267

(57) ABSTRACT

The invention relates to a method, system, method of doing business, and computer program product for providing instruction and device training. More particularly, the invention provides information and training around medical, veterinary and anatomical procedures. The procedures are presented as a multimedia interactive platform to provide improved instruction and training.

### FIELD OF THE INVENTION

The invention relates to a method, system, method of doing business, and computer program product for providing instruction and device training. More particularly, the invention provides information and training around medical, veterinary and anatomical procedures.

### BACKGROUND

The present invention relates to method, system, method of doing business, and computer program product for providing instruction or training on the conduct of a procedure or the use of a device. The training of medical professionals in new procedures or the use of a new medical device causes a particular problem. While it is widely recognized that these medical professionals need to have new training in the new procedure or use of a new device it is inappropriate to allow such training to occur in situ at the first instance.

A number of solutions are offered in training hospitals. These include allowing a trainee doctor or medical professional to observe procedures as they are performed by a more experienced professional. This provides a trainee with the environment that will be experienced when conducting a procedure. However, the trainee is an observer and is not usually involved in performing the procedure. In addition, where trainees are observing procedures, the time taken for the procedure is increased. This increases costs and increases the risks to the patient.

Simulators are also used for training. The simulators currently in use provide a detailed model which, when used in combination with software provide a feel for performing the procedure. The simulators typically provide an environment that mimics the tactile and visual feedback experienced when performing a particular procedure or utilizing a particular device.

The advantage of such a simulator is that trainees are required to make decisions and respond to the stimuli presented. However, simulators tend to be very expensive. They are usable typically only by one person at a time and are bulky and not very mobile. Simulators are focused on a particular procedure or device and have only limited ability to adapt to alternate procedures or devices.

As such, only well-funded hospitals or teaching facilities are able to provide a suite of simulators which are able to provide instruction on a range of procedures or devices.

Medical professionals can also acquire information by reading text books and journal articles. Text books and journal articles are readily available and contain extensive information. In addition, while they are or can be costly, the cost is significantly less than that of the simulators.

Text books and journal articles can be time consuming and difficult to read. The information uptake by the professional can be limited. Text books tend to include in-depth information which may not be required by the trainee or which cannot be effectively learned by the trainee. In addition, text book and journal information is static rather than interactive.

Accordingly, there is need for a training system that falls between the general information offered by text books and the extremely focused information and training offered by simulators.

### OBJECT

It is an object of the present invention to provide a method, system, method of doing business, and computer program product for providing instruction or training on the conduct of a procedure or the use of a device, or one which will at least provide the public with a useful choice.

### SUMMARY OF THE INVENTION

A first embodiment of the present invention is a method for providing instructional information about a medical procedure or the use of a medical device. The method includes the following steps:
A request for training on a procedural device is initiated by a user logging on;
The request triggers the launching of a computer-based application;
The computer application prompts the user to select a desired procedure or device;
Once the user has selected the desired procedure or device, information from an information module is launched.

The information module includes at least one of:
anatomical information;
device information;
procedural information;
practice module;
test module; or
multi-media information
   relating to the use of the device or the carrying out of the procedure.

Launching the practice module creates a virtual environment. Within the virtual environment, a user can practice the procedure or the use of the device.

Rather than practice the procedure or use of the device, the user may test their knowledge in the virtual environment. The test module provides the same virtual environment as the practice environment. The user carries out the procedure or uses the device in the simulated environment. The efforts of the user and the carrying out in the simulated environment are assessed and results provided. If desired, completion of the different modules, together with test results, can be stored in a central repository.

A second embodiment of the present invention is a system for providing instruction or training in a procedure or the use of a device. The system includes:
a network;
a user computer coupled to the network for requesting information on the use of the medical device or carrying out of the procedure; and
a server which stores a database including details of available information modules relating to various procedures and devices together with the information modules themselves.

A user sitting at a user computer can log into the server. This log-in triggers a request for the server to provide a list of available information modules. In response to this the user can then, at their user computer, request delivery of one or more of the information modules. In response to this request the server will provide or deliver the selected information module. The user can then navigate within the information models on the user computer.

A third embodiment of the present invention is a computer program article of manufacture. The article of manufacture includes a computer readable medium for providing instructional information and training on procedures or the use of medical devices. The computer readable medium is provided with executable instructions for receiving a request for instructional information on a procedure or device, providing a first graphical user interface having a list of instructional topics associated with the selected procedure or device.

The computer readable medium is also provided with information modules which include multi-media data relating to at least one of:
anatomical information;
device information;
procedural information;
practice module;
test module; or
multi-media information
   relating to the use of the device or the carrying out of the procedure.

The practice module in the computer readable medium provides a further graphical user interface allowing practice of the procedure or use of the device in a simulated or virtual environment.

A further graphical user interface is provided allowing users skills or learning to be tested in that virtual environment.

A fourth embodiment of the invention is a business method for providing instructional information on a procedure or medical device in the business method instructional training on a procedure or device provided over a network.

A central server provides a repository of information modules relating to various devices or procedures. A client or user initiates a request, which is forwarded to the central server. In response to the request a list of available procedures or devices is provided. A user selects the procedure or device of interest and the user's computer requests the relevant information modules from the server. The business method then provides the information module selected procedure or device to the user via the user computer.

In a related aspect, the invention comprises a system for providing instructional information about a medical procedure or the use of a medical device.

The system comprises providing information within a multimedia presentation, which includes information relating to at least one procedure.

The information comprises at least three components:
anatomical information relating to the medical procedure;
text instructions relating to a medical procedure; and
a narrated video clip showing the operation in progress.

Preferably the three components are displayed in separate windows on a single display, so that all windows may be viewed at the same time.

Ideally the windows are of different sizes with a main window and subsidiary windows. A user is able to select which information is displayed in the main and subsidiary windows.

The anatomical information may comprise of 3D images of the anatomy relevant to the procedure. A user is able to manipulate the images to change the view or to select specific portions to get more information or a more detailed view.

The text instructions will provide details on the steps involved in the procedure.

The video clip will present the visuals from an example procedure. The narration describes the view and the steps being taken in the visuals.

Preferably the information will be presented chronologically, that is, in the order it would usually be required for the procedure.

Events that occur during the procedure are tagged. The anatomy and text information relating to each event are linked to the occurrence of that event on the video.

Thus the relevant anatomical and text information can be displayed at the appropriate time during the video clip.

Preferably the system also provides a practice module where the user is able to practice the procedure. In this mode the user is able to select and manipulate the instruments they wish to use in performing the procedure. The selection and manipulation can be performed using a mouse or other interface. The time taken is tracked and the user is shown the appropriate anatomical and text information for the stage they are at in the operation.

The system of the present invention can be used with multiple devices. Preferably the multiple devices can be used in combination. For example, if 2 mice are used, one will be manipulated by each hand of the user.

In addition, the simulator may be used as an assessment tool, where the information windows are hidden and the user is required to perform the procedure based on their own knowledge.

It is envisaged during an assessment the user will be scored on the procedure. The score may be kept in a central repository and may be made available to the users' supervisors or trainers.

The assessment mode may have a variety of difficulty levels, which introduce different complications for the user to deal with.

The system of the present invention is advantageous as it allows the user to track the progress of a procedure and provides them with a view of what they may see at different times during the procedure. In addition, the simultaneous presentation of the relevant anatomy, video, narrative and text information provides the relevant information in a range of formats increasing the exposure of the user to the information and increasing the uptake of the information.

The module-based nature of the system is advantageous as it provides at once a context for the learning, making it more interesting and memorable. The procedures are also then available for revision before an operation is undertaken. The video clip in this sense providing valuable information to a practitioner performing an unusual procedure or one with which they are not familiar.

In another aspect the invention comprises a method of creating modules suitable for use in the system.

It has been found that the preferred starting place for creating the module is the video clip. This provides the events and timeline of the procedure. The other media can then be built about the timeline. Anatomical information and text about the procedure can be included and tagged to the specific events.

In a further aspect the invention relates to a module based learning system.

Preferably each module will include the information necessary to perform a particular procedure.

More preferably different modules will cover different procedures.

More preferably the different modules will all run under the same programme and will interact with the central repository so that a user's score over a range of procedures are recorded.

As will be appreciated the system is useable not only for surgical procedures but also in other medical fields such as anaesthesia, dentistry, and veterinary science.

It is preferred that the invention be presented as a computer program suitable for loading on a central server. Users can then log into the server either through a local area network or over the Internet. Alternately the program can run locally on a computer.

As will be appreciated by those skilled in the art, the invention is software based and as such can be run on a computer or any console, which allows presentation of visual information and selection of the different windows. Suitable consoles may include tablet PCs, PlayStations, PlayStation II's, Xboxes and the like.

Portable devices such as PDAs, mobile phones and Sony Playstation Portable (PSPs) would also provide suitable hardware to run the invention or at least specific modules.

Various devices are useable to provide the interface with the system. Suitable devices include, by way of example only, mice, keyboards, track balls, stylus, joysticks, gloves and the like. Any such device is useable with the invention.

In the present aspect the system has been described as being organised based on particular procedures. This does not have to be the case. Stand-alone introductions to anatomy, surgery, and the like covering basic information would also benefit from the system. The integration of the different information is advantageous to the learning of the user.

In a final related aspect the invention may be used to illustrate the use of new medical devices or instruments.

As such it may be used to teach professionals about new devices and how they might be used.

As will be readily appreciable to those skilled in the art, the invention in any of its various aspects may be used as a promotional tool with little modification. Such use would allow vendors of medical devices or instruments, medicines and the like, to introduce a new medication or device to professionals within a virtual environment. This is advantageous over existing methods as it allows rapid distribution of knowledge about the new device, within a no-risk environment.

The invention may also be used to advertise various tools or products. This may be by sponsored advertisements in various multimedia windows as product placements, where appropriate, in the simulators.

### BRIEF DESCRIPTION OF THE DRAWINGS

The details of the present invention, both as to its structure and operation can best be understood by referring to the following description, with reference to the accompanying drawings in which:

FIG. 1 is a diagram of a network in accordance with the preferred embodiment of the present invention;

FIG. 2 is a flow diagram depicting the method for providing instruction or training in relation to a procedure or device in accordance with an embodiment of the present invention;

FIG. 3 is an exemplary loading screen showing the software loading over the windows environment;

FIG. 4 is an exemplary training topic screen in accordance with an embodiment of the present invention;

FIG. 5 is an exemplary screen showing the entry into a selected procedure;

FIGS. 6 to 12 are training information screens in accordance with the embodiments of the present invention.

### DETAILED DESCRIPTION OF THE INVENTION

The present invention is now described more fully hereinafter with reference to the accompanying drawings. The drawings show preferred embodiments of the present invention. The present invention may be embodied in many different forms and should not be construed as being limited to the embodiments set forth herein. Appropriately the preferred embodiments are provided so that this disclosure will be thorough and complete, and will fully convey the scope of the present inventions.

As will be appreciated by one having skill in the art, the present invention relates to a method, system, computer program product and method of doing business. The computer program product includes a computer readable storage medium having computer-readable program instruction stored in the medium. Any suitable computer readable medium may be utilized including hard discs, CD-ROMs, floppy discs, optical storage devices, magnetic storage devices etc.

The preferred embodiments refer to the use of computers. Those skilled in the art will appreciate that the user computer can be any device, which is capable of running the information media or multi-media information in a multi-media format. By way of example suitable devices may include mobile computing devices such as PDAs, PSPs, and the like.

The following description refers to a server having a plurality of information modules relating to a number of different procedures or devices. Those skilled in the art will appreciate that stand alone modules which feature a single device or a single procedure will also fall within the scope of the invention. It is considered stand-alone modules combining information relating to a single procedure or device will be particularly advantageous for mobile devices.

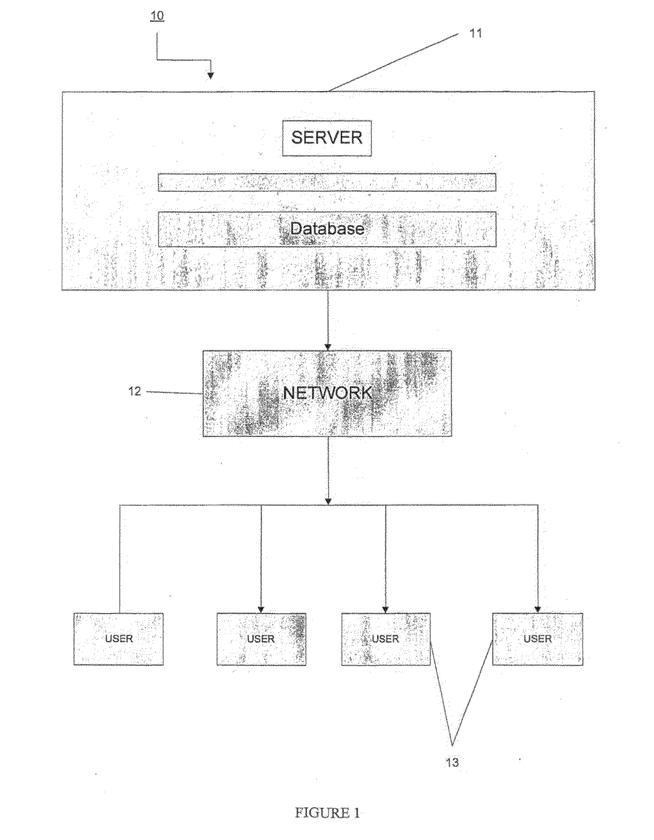

FIG. 1 is a diagram of a system in accordance with the preferred embodiment of the invention. In the preferred embodiment of FIG. 1, the system 10 includes a server 11, a network 12 and user devices 13. The server acts as a repository for the various information modules relating to the devices and procedures supported by the system. The server will typically interact with the user devices 13 over a network 12. The network 12 can be a WAN such as the internet. Alternately, the network could be a LAN such as an intranet. Where wireless or blue tooth capable devices are used as the client or user device the wider communication methods can be used.

In addition to storing the information modules and associated graphical user interfaces, the server 11 may also have a database. The database can keep track of the users of the system. It may be desirable to retain records, which record the use and progress of various users through the modules recorded on the system.

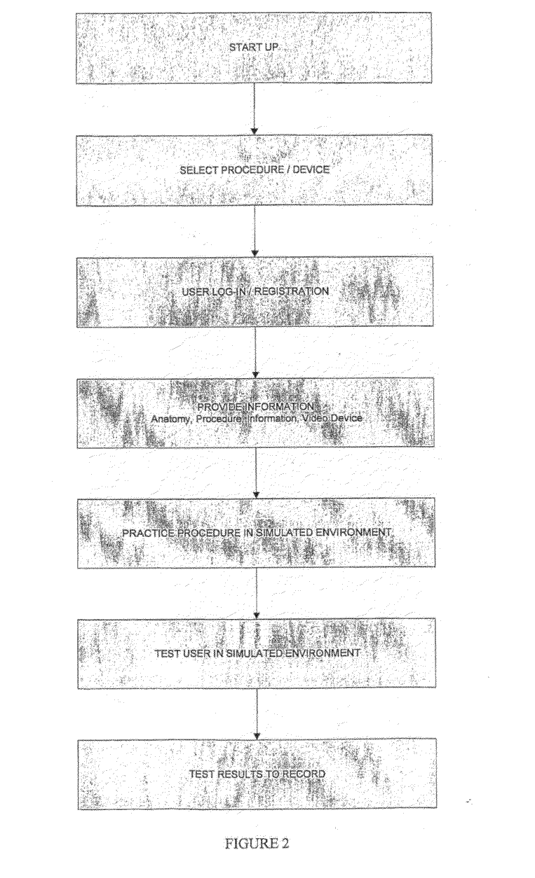

FIG. 2 is a flow diagram depicting a method of providing instructional training in a procedure or device in accordance with an embodiment of the present invention.

FIG. 2 details at a high level the instructional or training process of the preferred embodiment. The training is initiated when a user requests start up of the training software.

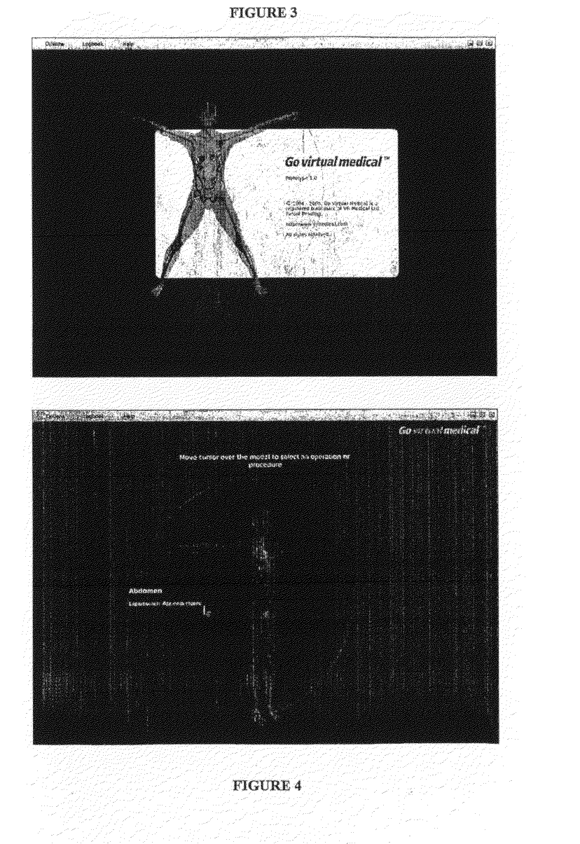

The user is then prompted to select a procedural device from a menu. An example menu is shown in FIG. 4. In this example the menu just illustrates a single option.

Once the relevant procedure is selected an introductory screen relating to that procedure or device will appear. An example is shown in FIG. 4.

The introductory screen provides details around the selected procedure; in this case a laparoscopic appendectomy and users are invited to log in. Once log-in details are confirmed information modules are provided from the central server to the user. The information modules include multi-media information and text. As can be seen from FIGS. 6 to 8, anatomical information, simulation, video and operative text information is provided.

Once that information is absorbed the user proceeds to practice the procedural practice using the device within a procedure in a virtual environment. A screen shot from this virtual simulation is shown in FIG. 10. Once the user is satisfied that they have sufficiently practiced the procedure or using the device a test mode can be entered. The user performs the procedure or uses the device without the benefit of any training or reference material. The user's performance is compared to a reference performance and results are provided to the user.

Where a user has logged in or registered those results can also be included in a central repository. The centralized information can be used for the users own reference or for the reference of the user's instructors.

FIGS. 3 to 11 are derived from the preferred embodiment of the invention. In this case, the system features a single procedure. However the invention is readily adaptable to other procedures and medical devices.

In the preferred embodiment the system is presented as a computer program. Ideally it is loaded onto a central server with users logging in from terminals or networked computers.

The computers may be connected via an internal network such as an intranet or an external network such as a WAN or telecommunications network. It is possible to run the invention on a standalone device. In this case, the device would serve as the user device and the server. Such a system would be particularly useful for mobile devices such as PSPs, PDAs and the like.

An initial loading screen is shown in FIG. 3. This shows the programme loading over the Microsoft Windows™ environment. The invention is not limited to this environment.

FIG. 4 shows the opening screen of the program. This screen allows users to select the procedure or device they wish to learn about. As is clear from FIG. 4, the user can move their cursor over different parts of the screen to select a particular procedure or device. In the preferred embodiment the procedures are arranged in accordance with anatomy. Where devices are selected it is envisaged that the devices will feature procedures they can be utilized in.

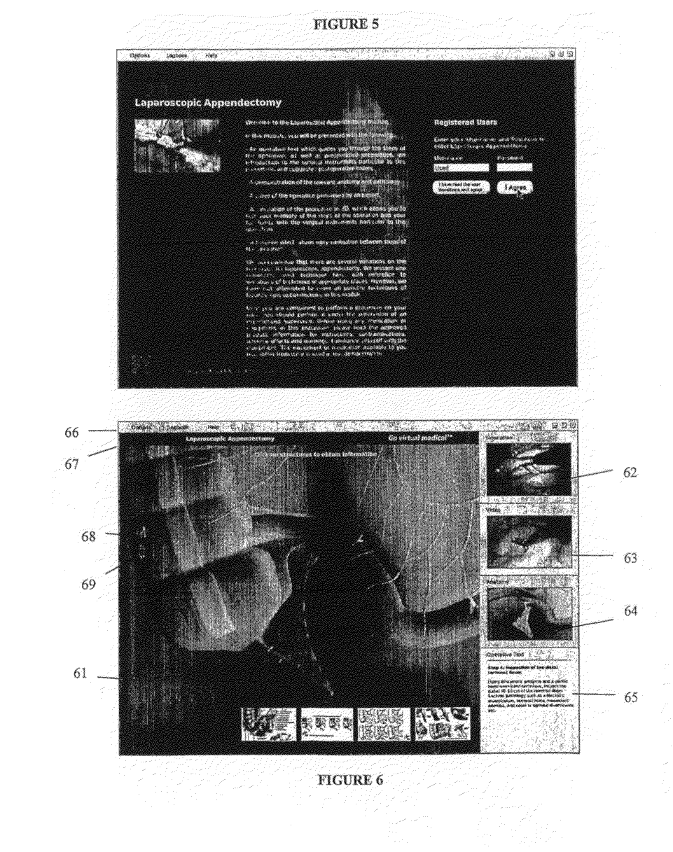

The welcome screen for the laparoscopic appendectomy procedure is shown in FIG. 5. This provides an introduction to the information module. It outlines the components of the module. These include the operative text, a display of the relevant anatomy and pathology, and a video of the operation performed by an expert. In addition it introduces the virtual environment for practicing the procedure and testing a user's knowledge. The welcome screen prompts registered users to log in. The log-in process allows the system to identify the user. This allows records to be kept of the user's completion of the module and their results from any assessment. The registration and log-in process can also be used to monitor and record usage for billing or licensing purposes.

Once a user has completed the log-in process the training module launches. The module includes information in a variety of different formats. These include 3D anatomical models, video of the procedure, operative text and a simulated or virtual environment.

FIG. 6 is a screen shot from the laparoscopic appendectomy information module. The main window 61 shows the anatomical information. The subsidiary windows 62, 63, 64 and 65 display further components in the module. The screen features a banner 66 and a menu 67. As shown in FIG. 6, the top menu also provides access to other features including search functions, logbook, tutorials and setup options. The setup options are important as they provide the flexibility to use the software on existing equipment that the hospital or teaching institution is likely to already have or is able to acquire at minimal cost.

The main window 61 displays an image of the relevant anatomy. The image can be manipulated using rotational controls 68 and 69. The rotational controls allow the image to be moved or rotated.

Clicking on the various structures displayed causes further information to be provided. In addition the main window features thumbnails of other images in the particular component. A user may select any of the subsidiary images to activate that component of the information module.

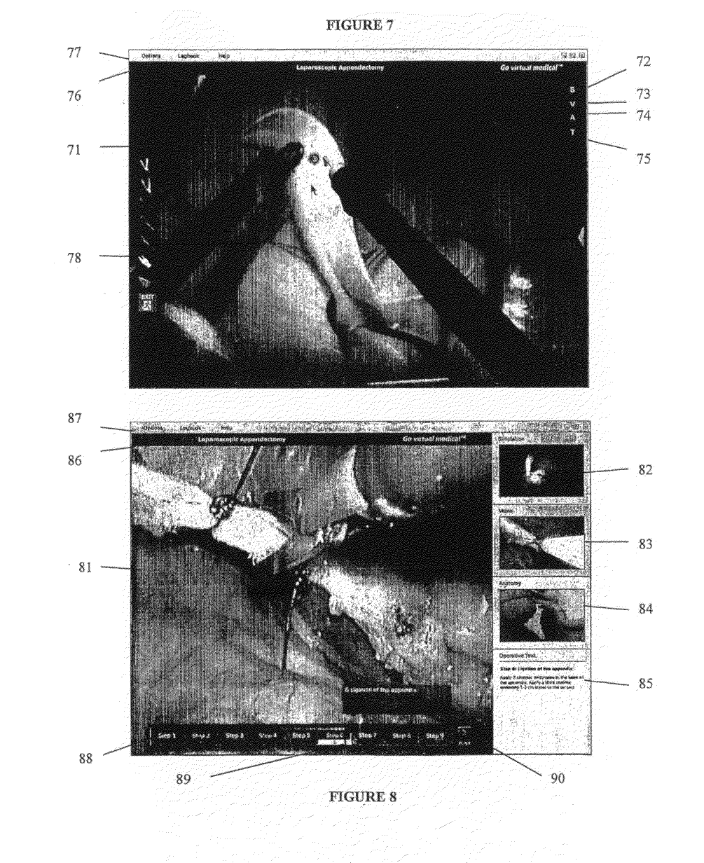

FIG. 7 is a screen shot of the virtual procedure environment. In simulation mode the subsidiary windows, present in the view shown in FIG. 6 are absent. They are replaced with buttons S, V, A, T (72-75) shown on the right hand portion of the window. Clicking on these buttons returns the user to the video, anatomy or text modes. As with the screen shot in FIG. 6, the window in FIG. 7 has a banner confirming the procedure being performed. The screen also features a menu 77 providing further options to the user.

In the simulation mode a user requires two means of interacting with the simulator. Typically this will be in the form of two mice, one for the left hand and one for the right. Each of the ‘mice’ controls a separate cursor. These can be used to select instruments from the instrument selection panel 78. To select an instrument the cursor is moved over the image in the selection panel. Clicking on the image will select that instrument with that mouse or that cursor. The mouse associated with that cursor can then be moved. Doing so will also move the instrument. Clicking and holding will operate the instrument. In this case each of the selected instruments are operated using one of the two mice associated with the user device.

In addition to the simulation mode a video footage from the surgical procedure being dealt with in the information module is available. FIG. 8 shows the information module in video mode. The main window 81 shows footage taken during a laparoscopic appendectomy.

In addition to the main window 81 there are subsidiary windows 82, 83, 84 and 85. The first of these shows the simulation at the same stage of the operation. The video subsidiary window 83 shows the relevant video image on a video still. The anatomy subsidiary window 84 provides an image of the anatomical drawings relating to the specific stage of the procedure. Finally the text subsidiary window 85 details the actions that take place during the relevant step of the operation.

The screen shot additionally features a banner 86 detailing the procedure being looked at and a menu 87 featuring further options and assistance that is available to the user.

The video mode additionally features a timeline 88. The timeline indicates what stage of the procedure is being displayed in the main window. A redline 89 indicates the particular sub-stage the operation is at. A description or label for that step is shown in information window 90.

When playing the video a user is able to rewind the operation and review particular steps as desired. In addition the operative text in subsidiary window 85 will reflect the actions being taken in the video in the relevant steps.

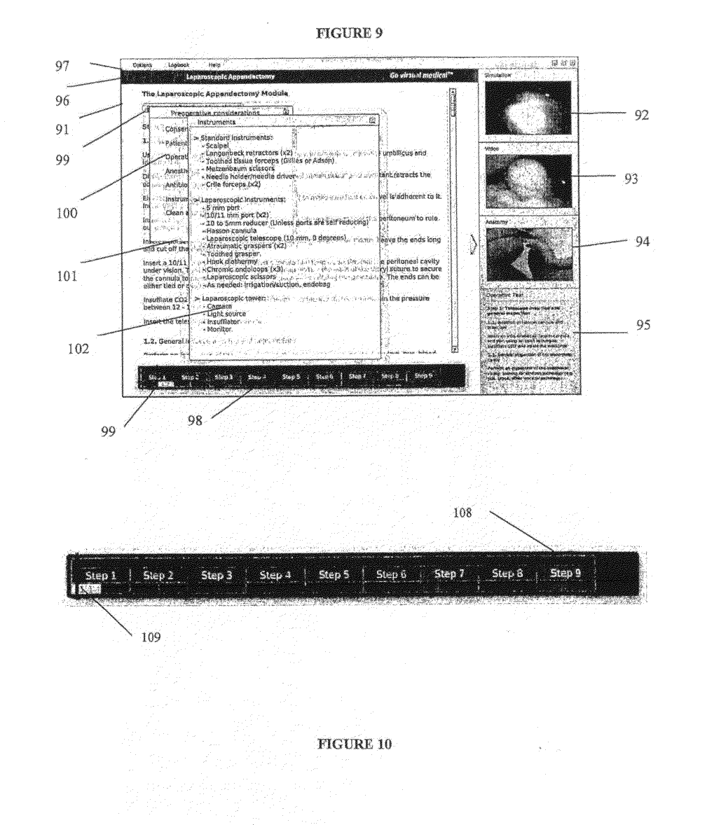

FIG. 9 displays the operative text component of the information module. The operative text is displayed in the main window 91. The subsidiary windows feature the simulation 92, the video 93, the anatomy 94, and the operative text 95. A banner 96 and menu 97 are also present on this view. As seen in FIG. 7, a timeline 98 is also present on this view. The timeline features an indicator 99. The indicator moves on cue with the different steps as outlined in the operative text. The video, described above, is also cued in relation to those specific steps. The main window 91 details the text information for the specific steps. In addition this window includes buttons, which can be pressed to provide further information relevant to the procedure. In this case, button 99 provides pre-operative considerations. Selecting this button with the cursor or clicking on the button with the cursor causes pop-up menu 100 to appear. This then gives you a further menu, which provides topics for further information that the user may want to consider.

In this case the user has selected the link to instruments 101. Clicking on this button 101 causes a further information window 102 to pop up. This window is titled ‘instruments’. This window details the range of devices or instruments that would typically be used in a laparoscopic appendectomy.

As with the video mode, moving the individual indicator 99 from one step to another will cause the relevant operative text to appear in the main window. In addition the video and simulation anatomy window will be cued to provide the information relevant to that specific step.

FIG. 10 provides a detailed view of the timeline. The timeline 108 is divided into nine steps. Each of these steps relates to a part of the procedure of interest. In addition each of these steps may be further divided into two or more sub-parts. A visual indicator 109 is provided. The visual indicator 109 tracks progress through the procedure.

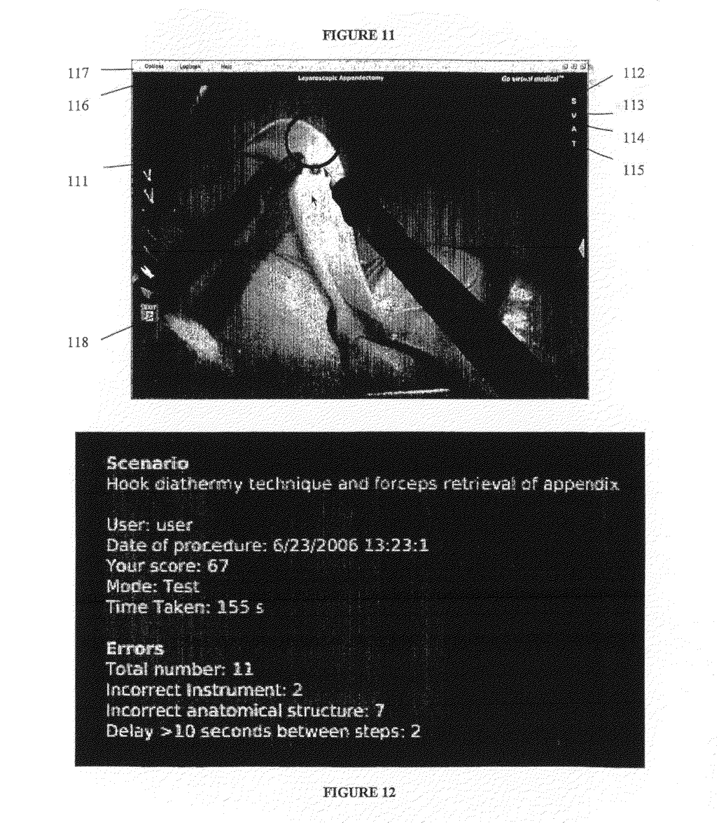

FIG. 11 provides a display of the invention in simulation mode. In this case the user is training on the invention. As with FIG. 7, the main view 111 is expanded to fill the whole screen. The subsidiary windows are replaced by buttons 112, 113 for video, 114 for anatomy and 115 for text information.

The banner 116 and the menu options 117 are present.

In addition to those the instruments selection panel 118 is present. In this case the user is operating a first instrument 119 with a first interactive device such as a mouse and a second device 120 with a second interactive device such as a second mouse. When the module is in training mode a green circle or dot provides an indication to the trainee or the user that they are in the right space to operate the instrument. Where the user has the instrument located in the incorrect portion of the anatomy a red dot will appear to indicate that they have made an error. Similarly green and red dots will appear in the selection over the instrument selection panel to indicate that the user has selected the correct or incorrect instrument given the stage of the operation or procedure.

When the informational module is in test mode the red and green dots don't appear. In addition a record will be kept of the number of mistakes that a user makes either with respect to instrument selection or with instrument placement in an operation. These results will be recorded and at the end of the procedure a result sheet will be presented to the user. An example of a result sheet that might be used in the preferred embodiment is shown as FIG. 12.

As can be seen the result sheet shows the scenario which is simply a description of the procedure that was undertaken, the user name, the date and time they made the attempt, the score and the mode. In addition, the time taken to complete the procedure is presented to the user. As will be appreciated the time taken is important as it effects the time that a person may be in the operating theatre. In addition to those parameters the error rate of the user is also recorded. The total number of errors is indicated together with the type of error. Errors include erroneous instrument selection, anatomical structure selection and delay between doing the different steps in the procedure.

These results can be used to track a user's progress. In which case they would be stored in a central repository such as a database located on the server. The improvement over time of the user or simply the completion of the user of a range of different procedures can then be tracked.

The results stored on the server could also be accessed by the user's supervisors or trainers and used to assess whether they are ready to be involved in a surgery or procedure or be selected to observe such a procedure.

While the above description has focused on a particular procedure, the invention could equally be applied to exemplify the use or appropriate use of a medical device or instrument. In such a use we would envisage the procedures that can be selected would be limited to those which use the device to best effect. In addition the module may be limited just to those steps which employ the device.

The advantage of the present invention is that it presents all necessary information for a procedure or the use of a device in a single multi-media package. This aids users in their learning by showing the interaction between the anatomy, text book and procedure information. In addition the variety of information presentation increases the uptake of the procedural information and detail by the user. The learning surrounding the procedure is made more interesting and is reinforced by immediate application of the text book knowledge into a simulated virtual environment.

This makes the learning process more interesting and gives the information context. This combination is useful in teaching medical, veterinarian and dentistry professionals. The system and method of the present invention is advantageous in that it enables the training to take place in a safe environment without endangering patients. In addition trainers can measure the competence of a trainee before allowing them to operate or participate in an operation on a real patient.

In addition to the above the present invention may be used to present information relating to the use of a novel device or tool. By building a module or integrating a virtual tool into an existing module a surgeon or other professional can be shown how a new device might be used in a given procedure. The invention will allow rapid dissemination of information about the new device. In addition the impact that is likely to be made on medical professionals looking at the new device is significantly enhanced. The professional will be able to utilize the new device in the virtual environment and the actual procedure in which the manufacturers of the device envisage it will be utilized. This provides a professional with a very real sense of where the device might be useful.

The invention may also be used as an advertising media for the promotion of various tools or products. This may be in the form of sponsored advertisements in various multi-media windows or as product placements, where appropriate, in the virtual environments.

Splash screens or the like may also be used to promote various devices, medicines or products.

1-15. (canceled)

16. A system for providing instruction or training regarding the conduct of a procedure or use of a device, the system comprising a display providing the user with a multi-media presentation including the components:
(a) Anatomical information relating to the procedure or relevant to the use of the device;
(b) Text instructions relating to the conduct of the procedure or use of the device; and
(c) A narrated video clip showing the conduct of the procedure or use of the device;
where the user is able to interact with the presentation to select and manipulate selected instruments with a computer interface device and conduct the procedure or use the device in a virtual environment.

17. The system as claimed in claim 16 where the selection and manipulation of instruments is performed using a computer interface device selected from the group including mice, trackballs, pens and the like.

18. The system as claimed in claim 17 where two or more interface devices are used contemporaneously.

19. The system as claimed in claim 18 where components (a) to (c) are displayed in separate windows in a single display so that all windows may be viewed at the same time.

20. The system as claimed in claim 19 where the windows are of different sizes with a main window and subsidiary windows the subsidiary windows being selectable.

21. The system as claimed in claim 18 where the anatomical information comprises 3D images of the anatomy relevant to the procedure.

22. The system as claimed in claim 21 where the user is able to manipulate the 3D images to change the view or to select specific portions.

23. The system as claimed in claim 18 where the text instructions provide details as to the steps involved in the procedure or use of the device.

24. The system as claimed in claim 18 where the video clip provides visuals from an actual procedure or use of the device.

25. The system as claimed in claim 18 where the narrated video clip describes the view and the steps being taken in the video clip.

26. The system as claimed in claim 19 where the components are indexed so that the anatomical information, text instructions and video clip relevant to each step of the procedure or use of the device are presented at the same time.

27. The system as claimed in claim 26 where the components are presented chronologically in the order required for conduct of the procedure or use of the device.

28. The system as claimed in claim 27 where the time taken by the user is tracked.

29. The system as claimed in claim 28 where the system is linked to a central server which contains a database which is capable of tracking the user's progress.

30. The system as claimed in claim 16 where the procedure or device is a medical procedure or device.
